(19) United States
(12) Patent Application Publication
(10) Pub. No.: US 2026/0093136 A1
(43) Pub. Date: Apr. 2, 2026

(54) DISPLAY DEVICE

(71) Applicant: SEIKO EPSON CORPORATION, Tokyo (JP)

(72) Inventor: Shinsuke FUJIKAWA, CHINO-SHI (JP)

(73) Assignee: SEIKO EPSON CORPORATION, Tokyo (JP)

(21) Appl. No.: 19/340,822

(22) Filed: Sep. 25, 2025

(30) Foreign Application Priority Data
Sep. 27, 2024 (JP) 2024-168301

(51) Int. Cl. G02F 1/133; G02F 1/1335; G03B 21/00

(52) U.S. Cl. CPC G02F 1/13318; G02F 1/133512; G02F 1/133524; G03B 21/006

(57) ABSTRACT

A display device includes: an exterior housing; a liquid crystal panel provided in the exterior housing and configured to radiate second light including light in a wavelength range longer than a first wavelength range when first light including light in the first wavelength range is incident; a photodetection unit configured to detect the second light and third light that is incident from outside the exterior housing; a first light guide unit configured to guide the third light to the photodetection unit; and a control unit configured to correct a detection value of the second light which is detected by the photodetection unit based on a detection value of the third light which is detected by the photodetection unit.

The present application is based on, and claims priority from JP Application Serial Number 2024-168301, filed September 27, 2024, the disclosure of which is hereby incorporated by reference herein in its entirety.

### BACKGROUND

### 1. Technical Field

The present disclosure relates to a display device.

### 2. Related Art

In a projection display device, light emitted from a light source is radiated to a transmission-type liquid crystal panel or a reflection-type liquid crystal panel, and transmitted light or reflected light modulated by the liquid crystal panel is projected onto a screen. In such a display device, the liquid crystal panel may deteriorate since the liquid crystal panel is irradiated with high-intensity light from the light source.

For example, JP-A-2008-40016 describes a liquid crystal display device in which chromaticity or illuminance of a light beam emitted from a liquid crystal panel is detected by an optical sensor, and an image quality state of an optical image is determined based on a detection result to control a cooling unit.

JP-A-2008-40016 is an example of the related art.

In the display device as described above, it is desired to accurately detect a deterioration degree of the liquid crystal panel.

### SUMMARY

According to an aspect of the present disclosure, a display device is provided. The display device includes: an exterior housing; a liquid crystal panel provided in the exterior housing and configured to radiate second light including light in a wavelength range longer than a first wavelength range when first light including light in the first wavelength range is incident; a photodetection unit configured to detect the second light and third light that is incident from outside the exterior housing; a first light guide unit configured to guide the third light to the photodetection unit; and a control unit configured to correct a detection value of the second light which is detected by the photodetection unit based on a detection value of the third light which is detected by the photodetection unit.

### BRIEF DESCRIPTION OF THE DRAWINGS

FIG. 1 schematically shows a display device according to an embodiment.

FIG. 2 schematically shows the display device according to the embodiment.

FIG. 3 schematically shows the display device according to the embodiment.

FIG. 4 is a plan view schematically showing a liquid crystal panel of the display device according to the embodiment.

FIG. 5 is a sectional view schematically showing the liquid crystal panel of the display device according to the embodiment.

FIG. 6 is a sectional view schematically showing the display device according to the embodiment.

FIG. 7 is a side view schematically showing the display device according to the embodiment.

FIG. 8 is a graph showing a temporal change in photoluminescence when a liquid crystal layer is irradiated with blue light.

FIG. 9 is a graph showing a temporal change in photoluminescence in an accelerated deterioration test of the liquid crystal panel.

FIG. 10 is a graph showing the temporal change in photoluminescence in the accelerated deterioration test of the liquid crystal panel.

FIG. 11 is a graph showing electro-optical characteristics of the liquid crystal panel.

FIG. 12 is a flowchart showing an operation of the display device according to the embodiment.

FIG. 13 is a sectional view schematically showing a display device according to a first modification of the embodiment.

FIG. 14 is a side view schematically showing the display device according to the first modification of the embodiment.

FIG. 15 schematically shows a display device according to a second modification of the embodiment.

FIG. 16 is a side view schematically showing the display device according to the second modification of the embodiment.

### DESCRIPTION OF EMBODIMENTS

A preferred embodiment of the present disclosure will be described in detail below with reference to the drawings. Note that the embodiment to be described below does not unreasonably limit contents of the present disclosure described in the claims. Further, not all configurations to be described below are necessary elements of the present disclosure.

### 1. Display Device

### 1.1. Overall Configuration

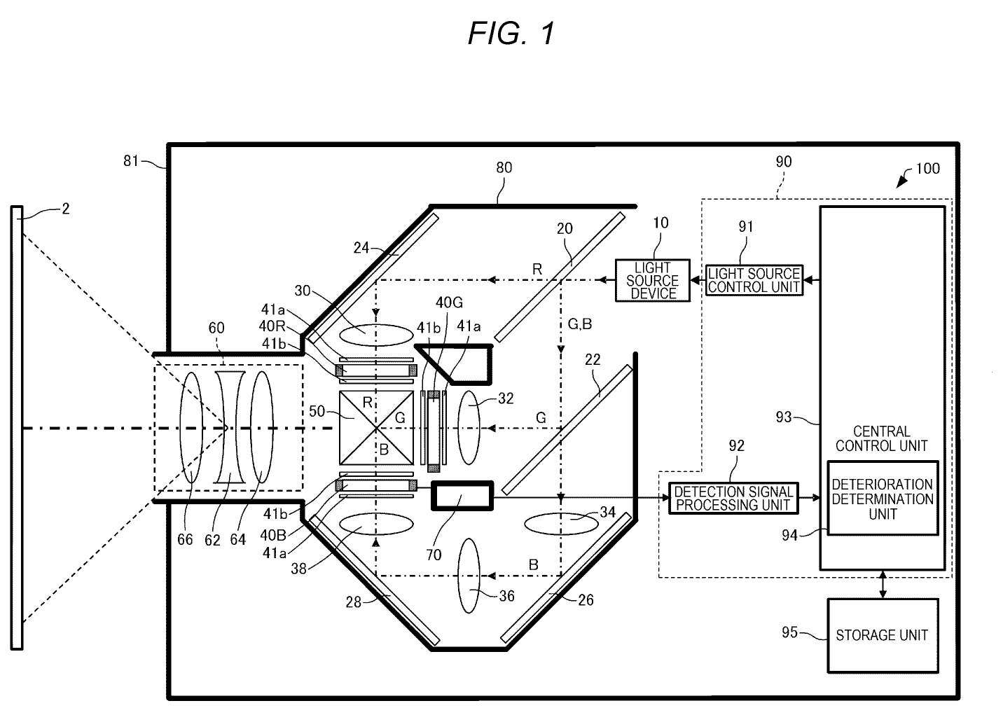

First, a display device 100 according to an embodiment will be described with reference to the drawings. FIG. 1 schematically shows the display device 100 according to the embodiment.

As shown in FIG. 1, the display device 100 includes, for example, a light source device 10, dichroic mirrors 20 and 22, reflection mirrors 24, 26, and 28, relay lenses 30, 32, 34, 36, and 38, light modulators 40R, 40G, and 40B, a cross dichroic prism 50 that is a light combining device, a projection optical system 60, a photodetection device 70, an optical component housing 80, a control unit 90, and a storage unit 95. The display device 100 is, for example, a 3LCD (liquid crystal display) projector.

Although not shown, the light source device 10 includes, for example, a light source and an optical system. The light source is, for example, a lamp unit including an array light source that includes a semiconductor laser, and a white light source such as an ultra-high pressure mercury lamp and a halogen lamp. Light from the light source is incident on the optical system. The optical system is, for example, an integrator lens that enhances uniformity of the light from the light source.

The dichroic mirror 20 transmits red light (R) and reflects green light (G) and blue light (B) of the light emitted from the light source device 10. The dichroic mirror 22 reflects the green light (G) reflected by the dichroic mirror 20 and transmits the blue light (B).

The red light (R) transmitted through the dichroic mirror 20 is reflected by the reflection mirror 24 and then incident on the light modulator 40R through the relay lens 30. The green light (G) reflected by the dichroic mirror 22 is incident on the light modulator 40G through the relay lens 32. The blue light (B) transmitted through the dichroic mirror 22 is incident on the light modulator 40B through the relay lens 34, the reflection mirror 26, the relay lens 36, the reflection mirror 28, and the relay lens 38.

The light modulators 40R, 40G, and 40B face respective light incident surfaces of the cross dichroic prism 50 on a color light basis. The light modulators 40R, 40G, and 40B modulate incident color lights based on image information (image signal).

The color lights modulated by the light modulators 40R, 40G, and 40B are emitted toward the cross dichroic prism 50. In the shown example, each of the light modulators 40R, 40G, and 40B is provided between a first polarizer 41a and a second polarizer 41b. Details of the light modulators 40R, 40G, and 40B will be described later.

The cross dichroic prism 50 is formed by bonding four rectangular prisms together, and a dielectric multilayer film that reflects red light and a dielectric multilayer film that reflects blue light are arranged in a cross pattern on an inner surface thereof. The three color lights are combined by the dielectric multilayer films into light representing a color image. The light combined by the cross dichroic prism 50 is emitted toward the projection optical system 60.

The projection optical system 60 projects the incident combined light onto a screen 2. The screen 2 displays an image in an enlarged manner. In the shown example, the projection optical system 60 includes, for example, a lens 62 that is a biconcave lens, a lens 64 that is a biconvex lens, and a lens 66 that is a biconvex lens.

The photodetection device 70 is provided to a lateral side of the light modulator 40B. The photodetection device 70 detects light emitted from the lateral side of the light modulator 40B when blue light is incident on a liquid crystal panel of the light modulator 40B. Details of the photodetection device 70 will be described later.

The optical component housing 80 accommodates, for example, the light source device 10, the dichroic mirrors 20 and 22, the reflection mirrors 24, 26, and 28, the relay lenses 30, 32, 34, 36, and 38, the light modulators 40R, 40G, and 40B, the cross dichroic prism 50, and the projection optical system 60. Examples of a material of the optical component housing 80 and an exterior housing 81 include metal and resin.

The control unit 90 includes, for example, a light source control unit 91, a detection signal processing unit 92, and a central control unit 93.

The light source control unit 91 is electrically coupled to the light source of the light source device 10. The light source control unit 91 controls the light source of the light source device 10. The light source control unit 91 generates a drive signal based on a signal from the central control unit 93 and transmits the generated drive signal to the light source of the light source device 10.

The detection signal processing unit 92 is electrically coupled to the photodetection device 70. The detection signal processing unit 92 acquires a detection signal from the photodetection device 70 and transmits the acquired detection signal to the central control unit 93.

The central control unit 93 controls the light source of the light source device 10 by the light source control unit 91. Further, the central control unit 93 acquires the detection signal from the photodetection device 70 by the detection signal processing unit 92. The light source control unit 91, the detection signal processing unit 92, and the central control unit 93 include, for example, an integrated circuit (IC).

The central control unit 93 includes a deterioration determination unit 94. The deterioration determination unit 94 determines a deterioration degree of the liquid crystal panel of the light modulator 40B based on the acquired detection signal. Specific processing of the deterioration determination unit 94 will be described later.

The storage unit 95 stores programs and data used for the control unit 90 to execute various computation processes and control processes. The storage unit 95 is implemented by, for example, a random access memory (RAM) and a read only memory (ROM).

In addition to a projector, the display device 100 is applicable to various electronic devices such as a liquid crystal panel of a photocurable 3D printer, an electrical view finder (EVF), a mobile mini projector, a head-up display, a smartphone, a mobile phone, a mobile computer, a digital camera, a digital video camera, a display, an onboard device, an audio device, an exposure device, and an illumination device.

### 1.2. Light Modulator

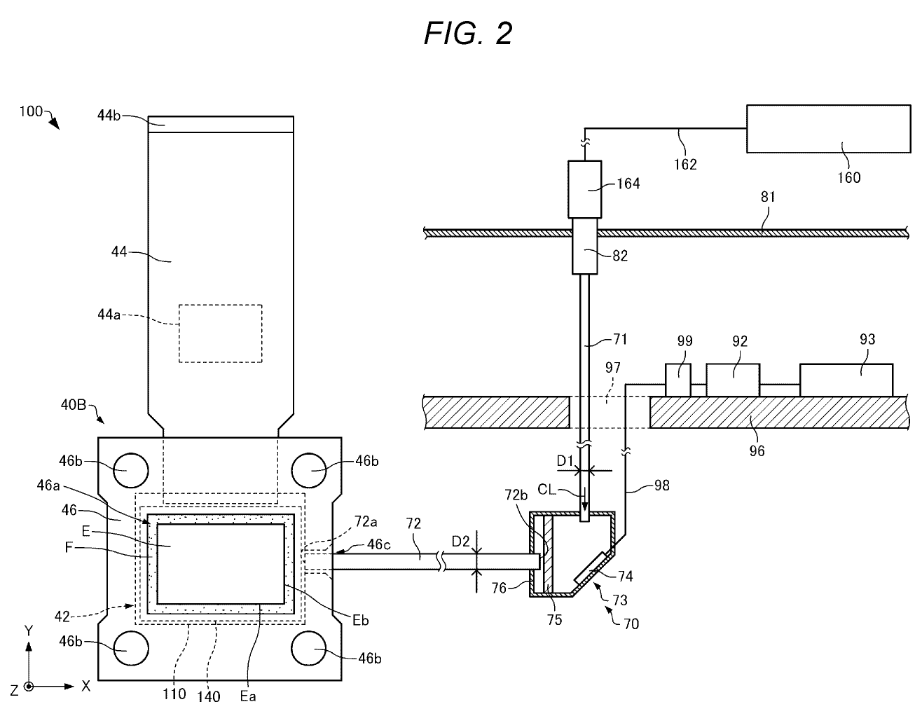

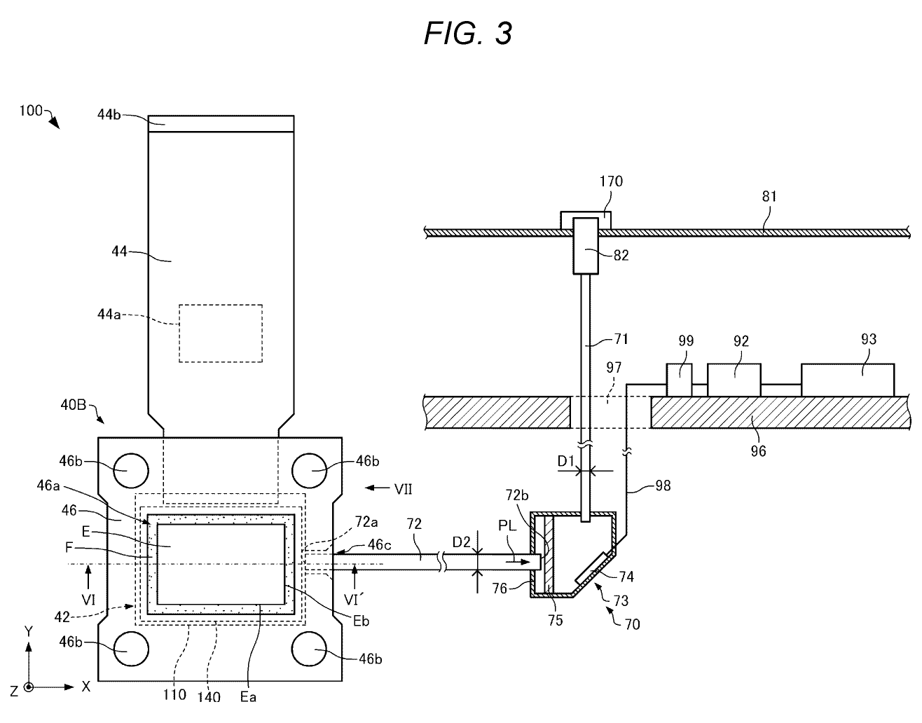

FIGS. 2 and 3 schematically show the display device 100. FIG. 2 shows a state in which a connector 164 is coupled to a coupling portion 82 fixed to the exterior housing 81. The exterior housing 81 stores the optical component housing 80, the light source device 10, and the control unit 90. FIG. 3 shows a state in which a light shielding cap 170 is coupled to the coupling portion 82. FIG. 2 shows an X axis, a Y axis, and a Z axis as three axes orthogonal to each other.

In the display device 100, for example, before the display device 100 is used as a projector, the connector 164 is coupled to the coupling portion 82 as shown in FIG. 2 to calibrate the photodetection device 70. After the photodetection device 70 is calibrated, the connector 164 is detached from the coupling portion 82, the light shielding cap 170 is coupled to the coupling portion 82 as shown in FIG. 3, and the display device 100 is used as, for example, a projector.

As shown in FIGS. 2 and 3, the light modulator 40B includes a liquid crystal panel 42, a chip on film (COF) 44, and a holder 46. The liquid crystal panel 42 modulates incident light based on image information. The liquid crystal panel 42 is an active drive liquid crystal panel having a thin film transistor (TFT) as a transistor on a pixel basis.

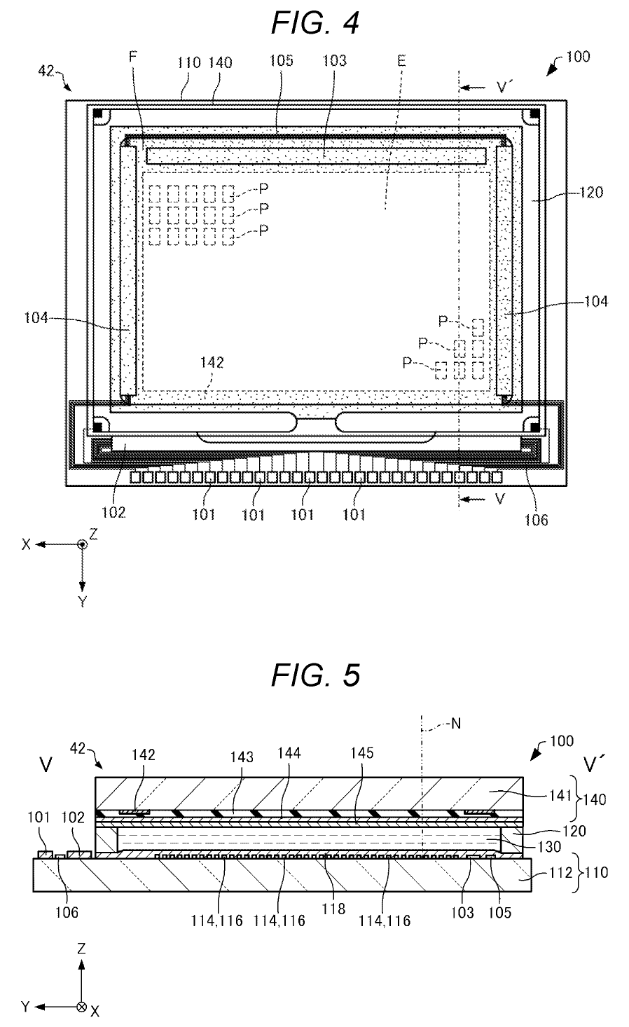

FIG. 4 is a plan view schematically showing the liquid crystal panel 42. FIG. 5 is a sectional view taken along a line V-V' in FIG. 4 that schematically shows the liquid crystal panel 42.

As shown in FIGS. 4 and 5, the liquid crystal panel 42 includes, for example, an element substrate 110, a sealant 120, a liquid crystal layer 130, and a counter substrate 140.

As shown in FIG. 4, the element substrate 110 of the light modulator 40B is larger than the counter substrate 140 when viewed from a normal direction of the element substrate 110 (hereinafter, also simply referred to as "when viewed from the normal direction"). The element substrate 110 has, for example, a quadrangular planar shape. The normal direction is a direction in which a normal line N of a surface on a liquid crystal layer 130 side of a first support substrate 112 of the element substrate 110 extends. The normal direction is, for example, a laminating direction of the element substrate 110 and the liquid crystal layer 130. In the shown example, the normal direction is a Z-axis direction.

The sealant 120 bonds the element substrate 110 and the counter substrate 140. The sealant 120 is provided along an outer edge of the counter substrate 140. The sealant 120 surrounds the liquid crystal layer 130 when viewed from the normal direction. The sealant 120 is, for example, an adhesive such as a thermosetting, photocurable, or electron beam-curable epoxy resin. Inward of the sealant 120, a display region E including a plurality of pixels P that are arranged in a matrix is provided. The display region E is surrounded by a peripheral region F. In the peripheral region F, a partition portion 142 surrounds the display region E between the sealant 120 and the display region E. A material of the partition portion 142 is, for example, a light shielding metal or a metal oxide.

The element substrate 110 includes, for example, external coupling terminals 101, a data line drive circuit 102, an inspection circuit 103, scanning line drive circuits 104, a first wiring 105, and a second wiring 106.

A plurality of external coupling terminals 101 are provided. In the shown example, the plurality of external coupling terminals 101 are arranged in an X-axis direction. The data line drive circuit 102 is provided between a first side along the plurality of external coupling terminals 101 and the sealant 120. The inspection circuit 103 is provided between the sealant 120 along a second side facing the first side and the display region E. The scanning line drive circuits 104 are provided between the display region E and the sealant 120 along a third side and a fourth side that face each other and are orthogonal to the first side. Although not shown, the inspection circuit 103 may be provided between the sealant 120 along the data line drive circuit 102 and the display region E.

The first wiring 105 is provided between the sealant 120 along the second side and the inspection circuit 103. The first wiring 105 is coupled to two of the scanning line drive circuits 104. The second wiring 106 is coupled to the data line drive circuit 102 and the scanning line drive circuits 104. The second wiring 106 is electrically coupled to the plurality of external coupling terminals 101.

As shown in FIG. 5, the element substrate 110 includes, for example, the first support substrate 112, pixel electrodes 114, TFTs 116, and a first alignment layer 118.

The first support substrate 112 supports the pixel electrodes 114, the TFTs 116, and the first alignment layer 118. The first support substrate 112 is, for example, a glass substrate or a quartz substrate. The first support substrate 112 transmits light emitted from a light source.

The pixel electrodes 114 and the TFTs 116 are provided on the liquid crystal layer 130 side of the first support substrate 112. The pixel electrodes 114 and the TFTs 116 are provided on a pixel P basis. A plurality of pixel electrodes 114 and a plurality of TFTs 116 are provided corresponding to a plurality of pixels P. The pixel electrodes 114 and the TFTs 116 constitute the pixels P. The pixel electrodes 114 are, for example, transparent electrodes such as indium tin oxides (ITOs) or indium zinc oxides (IZOs). The TFTs 116 are switching elements.

The first alignment layer 118 is provided on the liquid crystal layer 130 side of the first support substrate 112. The first alignment layer 118 covers the pixel electrodes 114, the TFTs 116, and the first wiring 105. The first alignment layer 118 is, for example, an inorganic alignment layer such as a silicon oxide layer or an organic alignment layer such as a polyimide layer.

The liquid crystal layer 130 is provided between the element substrate 110 and the counter substrate 140. The liquid crystal layer 130 is formed by encapsulating a liquid crystal having positive or negative dielectric anisotropy in a gap between the element substrate 110 and the counter substrate 140.

The counter substrate 140 is provided on an opposite side of the liquid crystal layer 130 from an element substrate 110 side. The counter substrate 140 faces the element substrate 110. Light emitted from a light source is incident on the counter substrate 140.

The counter substrate 140 includes, for example, a second support substrate 141, the partition portion 142, an insulating layer 143, a counter electrode 144, and a second alignment layer 145.

The second support substrate 141 faces the first support substrate 112. The second support substrate 141 supports the partition portion 142 and the insulating layer 143. The second support substrate 141 is, for example, a glass substrate or a quartz substrate. The second support substrate 141 transmits light emitted from a light source. When viewed from the normal direction, the second support substrate 141 has, for example, an area smaller than an area of the first support substrate 112.

The partition portion 142 is provided on the liquid crystal layer 130 side of the second support substrate 141. As shown in FIG. 4, the partition portion 142 overlaps the inspection circuit 103 and the scanning line drive circuit 104 when viewed from the normal direction. The partition portion 142 blocks light emitted from a counter substrate 140 side not to be incident on peripheral circuits such as the inspection circuit 103 and the scanning line drive circuit 104. Accordingly, malfunction of the peripheral circuits can be prevented. Further, the partition portion 142 reduces incidence of unnecessary stray light on the display region E. Accordingly, a decrease in contrast of the liquid crystal panel 42 can be prevented.

As shown in FIG. 5, the insulating layer 143 is provided on the liquid crystal layer 130 side of the second support substrate 141. The insulating layer 143 covers the partition portion 142. The insulating layer 143 is provided between the liquid crystal layer 130 and the second support substrate 141. A surface of the insulating layer 143 on the liquid crystal layer 130 side is, for example, a flat surface. The insulating layer 143 transmits light emitted from a light source. The insulating layer 143 is, for example, a silicon oxide layer.

The counter electrode 144 is provided on the liquid crystal layer 130 side of the insulating layer 143. The counter electrode 144 is provided between the liquid crystal layer 130 and the insulating layer 143. The counter electrode 144 is, for example, a transparent electrode such as ITO or IZO.

The second alignment layer 145 is provided on the liquid crystal layer 130 side of the counter electrode 144. The liquid crystal layer 130 is provided between the first alignment layer 118 and the second alignment layer 145. The second alignment layer 145 is, for example, an inorganic alignment layer such as a silicon oxide layer or an organic alignment layer such as a polyimide layer.

Liquid crystals constituting the liquid crystal layer 130 modulate incident light by changing an orientation or order of a molecular assembly in response to a level of a voltage applied between the pixel electrodes 114 and the counter electrode 144, enabling gradation display. For example, in a case of a normally-white mode, transmittance of the incident light decreases in response to a voltage applied to each pixel P. In a case of a normally-black mode, transmittance of the incident light is increased in response to the voltage applied to each pixel P, and overall, light having a contrast corresponding to an image signal is emitted from the display device 100. In the example shown in FIG. 1, the liquid crystal panel 42 is of a transmissive type, and may also be of a reflective type.

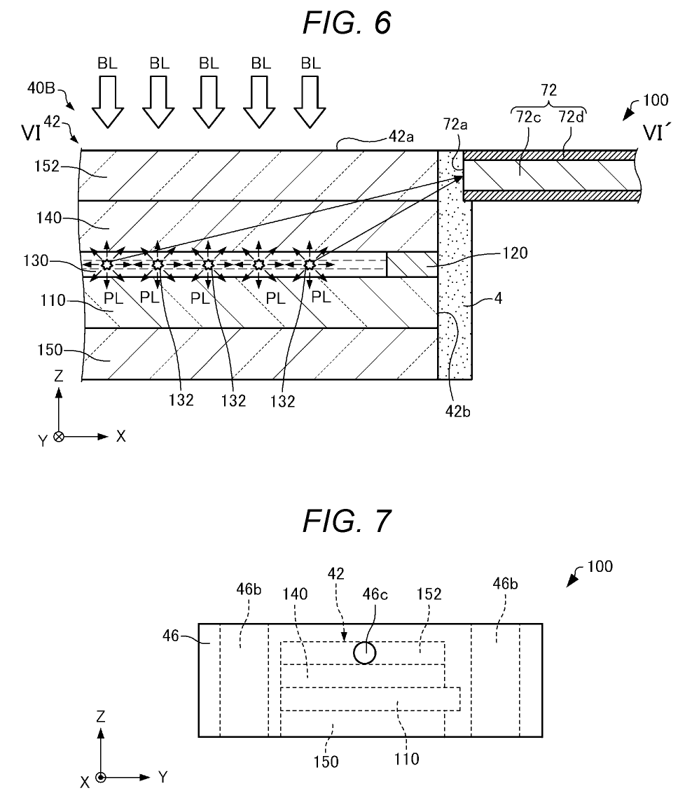

FIG. 6 is a sectional view taken along a line VI-VI' in FIG. 3 that schematically shows the display device 100. For convenience, FIG. 6 shows a second light guide unit 72 side of the photodetection device 70 from the sealant 120 on a VI side. In FIG. 6, members other than the liquid crystal panel 42, a second light guide unit 72, and an index matching material 4 are not shown. In FIG. 6, the liquid crystal panel 42 is shown in a simplified manner.

As shown in FIG. 6, the liquid crystal panel 42 further includes, for example, a first dustproof substrate 150 and a second dustproof substrate 152. The first dustproof substrate 150 is provided on an opposite side of the element substrate 110 from the liquid crystal layer 130. The element substrate 110 is provided between the first dustproof substrate 150 and the liquid crystal layer 130. The second dustproof substrate 152 is provided on an opposite side of the counter substrate 140 from the liquid crystal layer 130. The counter substrate 140 is provided between the second dustproof substrate 152 and the liquid crystal layer 130. The dustproof substrates 150 and 152 transmit light from a light source. A material of the dustproof substrates 150 and 152 is, for example, glass. Even when dust adheres to surfaces of the dustproof substrates 150 and 152, the dust can be made invisible since the surfaces are out of focus.

The liquid crystal panel 42 has a first surface 42a on which light BL, which is blue light, is incident and a second surface 42b intersecting the first surface 42a. In the shown example, the first surface 42a is implemented by the second dustproof substrate 152. The first surface 42a is a surface facing the normal direction. In the shown example, the first surface 42a faces a +Z-axis direction. The second surface 42b is coupled to the first surface 42a. In the shown example, the second surface 42b is orthogonal to the first surface 42a. The second surface 42b is a surface facing a direction orthogonal to the normal direction. In the shown example, the second surface 42b faces a +X-axis direction. The second surface 42b is a side surface of the liquid crystal panel 42.

As shown in FIGS. 2 and 3, the COF 44 is coupled to the liquid crystal panel 42. The COF 44 includes a drive IC 44a that drives the liquid crystal panel 42. The COF 44 further includes a connector 44b. The connector 44b may include a reinforcing plate. Although not shown, the connector 44b may be coupled to a circuit board 96.

The holder 46 supports the liquid crystal panel 42. In other words, the holder 46 accommodates the liquid crystal panel 42. An end portion of the COF 44 on an opposite side from the connector 44b is inserted to be fitted into, for example, a concave portion formed in the holder 46. A material of the holder 46 is, for example, metal or resin.

The holder 46 is formed with an opening 46a. The opening 46a overlaps the display region E of the liquid crystal panel 42 when viewed from the normal direction. The opening 46a is formed on a second dustproof substrate 152 side.

The holder 46 is formed with bolt holes 46b. In the shown example, four bolt holes 46b are formed. Bolts (not shown) are inserted into the bolt holes 46b. The holder 46 is supported in the optical component housing 80 by the bolts, and can be precisely positioned relative to the cross dichroic prism 50.

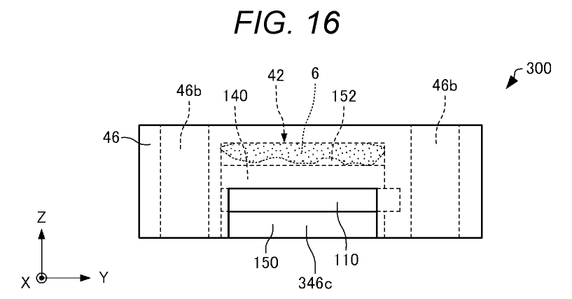

FIG. 7 is a side view schematically showing the display device 100, as viewed from a direction of an arrow VII in FIG. 3. For convenience, members other than the liquid crystal panel 42 and the holder 46 are not shown in FIG. 7. In FIG. 7, the liquid crystal panel 42 is shown in simplified perspective as a broken line. The liquid crystal panel 42 is basically hidden by the holder 46 and is not visually recognized when viewed from the direction of the arrow VII in FIG. 3. This also applies to FIGS. 14 and 16 to be described later.

As shown in FIGS. 3 and 7, the holder 46 is formed with a through hole 46c. The through hole 46c is formed in the holder 46 on a lateral side of the liquid crystal panel 42. As shown in FIG. 3, the display region E of the liquid crystal panel 42 has a shape having a longitudinal direction and a lateral direction when viewed from the normal direction. The shape of the display region E is, for example, a rectangle having a long side Ea and a short side Eb. The through hole 46c is provided on a short side Eb side of the display region E. For this reason, light PL can be simply integrated and detected along the long side Ea which is longer between the long side Ea and the short side Eb of the display region E. Accordingly, a deterioration degree of the liquid crystal panel 42 can be accurately detected. When viewed from the normal direction, the through hole 46c overlaps the second surface 42b of the liquid crystal panel 42 which constitutes the short side Eb. The through hole 46c is chamfered, for example. Accordingly, the second light guide unit 72 can be easily inserted into the through hole 46c. In the example shown in FIG. 7, the through hole 46c overlaps the second dustproof substrate 152 when viewed from the X-axis direction. The through hole 46c does not overlap the liquid crystal layer 130 when viewed from the X-axis direction.

Although not shown, the through hole 46c may overlap the counter substrate 140 as long as the through hole 46c does not overlap the liquid crystal layer 130. The second light guide unit 72 may have a light incident surface 72a provided on a long side Ea side of the display region E of the liquid crystal panel 42.

Although the liquid crystal panel 42 of the light modulator 40B is described above, the liquid crystal panels 42 of the light modulators 40R and 40G have basically the same configurations as the configuration of the liquid crystal panel 42 of the light modulator 40B except that the through hole 46c is formed in the holder 46. The light modulators 40R and 40G may also use the holder 46 formed with the through hole 46c for cost reduction.

### 1.3. Calibration Light Source And Light Shielding Cap

As shown in FIG. 2, a calibration light source 160 is provided outside the exterior housing 81. The calibration light source 160 emits light CL for calibrating a photodetection unit 74 of the photodetection device 70. The light CL emitted from the calibration light source 160 has an intensity greater than, for example, an intensity of the light BL incident on the liquid crystal panel 42 of the light modulator 40B. The calibration light source 160 is, for example, a laser or a light emitting diode (LED).

The light CL emitted from the calibration light source 160 is guided into the exterior housing 81 through an optical fiber 162, for example. The optical fiber 162 is coupled to the coupling portion 82 that is fixed to the exterior housing 81 by the connector 164. The connector 164 is attachable to and detachable from the coupling portion 82. The coupling portion 82 penetrates the exterior housing 81.

As shown in FIG. 3, in a state in which the connector 164 is detached from the coupling portion 82 and the light shielding cap 170 is coupled to the coupling portion 82 as shown in FIG. 3, the light CL is not incident into the exterior housing 81. The light shielding cap 170 prevents the light CL from being incident on a first light guide unit 71. The light shielding cap 170 is coupled to the coupling portion 82 by, for example, a screw or a latch mechanism. A material of the light shielding cap 170 is, for example, metal or resin. When a screw or a latch mechanism is used to install the light shielding cap 170, the light shielding cap 170 can be prevented from accidentally falling off.

### 1.4. Photodetection Device

As shown in FIGS. 2 and 3, the photodetection device 70 includes, for example, the first light guide unit 71, the second light guide unit 72, and a photodetector 73.

As shown in FIG. 2, the first light guide unit 71 guides the light CL emitted from the calibration light source 160 to the photodetection unit 74 of the photodetector 73. The first light guide unit 71 is, for example, an optical fiber. In the shown example, one end of the first light guide unit 71 is coupled to the coupling portion 82. The other end of the first light guide unit 71 is inserted into the photodetector 73. In the shown example, the first light guide unit 71 passes through an opening 97 formed in the circuit board 96. The light CL emitted from the calibration light source 160 is incident on the photodetection unit 74 through the first light guide unit 71.

As shown in FIG. 3, the second light guide unit 72 guides the light PL from the liquid crystal panel 42 to the photodetection unit 74 of the photodetector 73. The second light guide unit 72 is, for example, an optical fiber. The light incident surface 72a, which is one end of the second light guide unit 72, is inserted into the through hole 46c formed in the holder 46. The light incident surface 72a is provided on the short side Eb side of the liquid crystal panel 42. A light emission surface 72b of the second light guide unit 72 is inserted into the photodetector 73. The first light guide unit 71 has a diameter D1 smaller than, for example, a diameter D2 of the second light guide unit 72.

As shown in FIG. 6, the second light guide unit 72 includes a core 72c and a clad 72d surrounding the core 72c. When the blue light BL is incident on the liquid crystal layer 130, the second light guide unit 72 guides the light PL radiated from a deteriorating substance 132 of the liquid crystal layer 130 to the photodetector 73. Specifically, the light PL is incident on the second light guide unit 72 from the light incident surface 72a, passes through a boundary between the core 72c and the clad 72d while being reflected, is emitted from the light emission surface 72b, and is incident on the photodetection unit 74. Although not shown, the first light guide unit 71 also includes a core and a clad.

As shown in FIG. 6, the deteriorating substance 132 is generated in the liquid crystal layer 130 with light exposure during use. The deteriorating substance 132 is a substance generated by irradiating the liquid crystal layer 130 with the blue light BL. The deteriorating substance 132 radiates the light PL when the blue light BL is incident on the liquid crystal layer 130. The light PL is, for example, red light. The light PL is photoluminescence (phosphorescence) in the deteriorating substance 132. The light PL is radiated substantially isotropically from the deteriorating substance 132.

The light incident surface 72a of the second light guide unit 72 faces the second surface 42b of the liquid crystal panel 42. In the shown example, the second surface 42b includes a surface of the element substrate 110, a surface of the sealant 120, a surface of the counter substrate 140, and surfaces of the dustproof substrates 150 and 152. Further, the second surface 42b may include surfaces of the alignment layers 118 and 145 and a surface of the counter electrode 144. The light incident surface 72a is, for example, parallel to the second surface 42b. In the shown example, the second light guide unit 72 is parallel to the X axis.

The index matching material 4 is disposed between the light incident surface 72a of the second light guide unit 72 and the second surface 42b of the liquid crystal panel 42. A difference in refractive index between the index matching material 4 and the core 72c is smaller than a difference in refractive index between air and the core 72c. The index matching material 4 is formed of, for example, a silicon-based material. The index matching material 4 can reduce reflection of the light PL on the light incident surface 72a of the second light guide unit 72. Further, even when the second surface 42b has unevenness due to a manufacturing process, the index matching material 4 can reduce reflection due to the unevenness. Accordingly, the light incident surface 72a can be disposed in a desired posture.

The light incident surface 72a of the second light guide unit 72 does not overlap the sealant 120 when viewed from a Y-axis direction. The light incident surface 72a is not provided on a lateral side of the sealant 120. For this reason, it is possible to prevent the light PL detected by the photodetection unit 74 from being attenuated by passing through the sealant 120. Further, it is possible to reduce a variation in an attenuation rate of the light PL due to a manufacturing variation in a width of the sealant 120. In the shown example, the light incident surface 72a overlaps the second dustproof substrate 152 when viewed from the Y-axis direction. Although not shown, the light incident surface 72a may overlap the counter substrate 140 when viewed from the Y-axis direction.

As shown in FIGS. 2 and 3, the photodetector 73 is provided in the optical component housing 80. The photodetector 73 includes, for example, the photodetection unit 74, a wavelength filter 75, and a light shielding body 76. The photodetector 73 may be provided outside the optical component housing 80 or outside the exterior housing 81.

As shown in FIG. 2, when the light CL is emitted from the calibration light source 160, the photodetection unit 74 detects the light CL incident from the outside of the exterior housing 81. Further, as shown in FIG. 3, when the light BL is incident on the liquid crystal layer 130, the photodetection unit 74 detects the light PL emitted from the second surface 42b of the liquid crystal panel 42. Accordingly, the light BL in a first wavelength range that is incident on the photodetection unit 74 can be reduced compared to a case where, for example, the light PL in a longer wavelength range emitted in the normal direction is detected by the photodetection unit. The blue light BL includes, for example, light in the first wavelength range of 430 nm or more and 490 nm or less. The light PL and the light CL include, for example, light of 550 nm or more and 650 nm or less, which is a wavelength range longer than the first wavelength range. The photodetection unit 74 is, for example, a photodiode, a camera, or a spectrometer.

The wavelength filter 75 is provided between the light emission surface 72b of the second light guide unit 72 and the photodetection unit 74. The wavelength filter 75 is, for example, a wavelength cut filter that transmits the light PL and reduces the light BL. The wavelength filter 75 may completely cut the light BL.

The light shielding body 76 accommodates the photodetection unit 74 and the wavelength filter 75. The light shielding body 76 surrounds the photodetection unit 74 and the wavelength filter 75. The first light guide unit 71 and the second light guide unit 72 penetrate the light shielding body 76. A material of the light shielding body 76 is, for example, metal or resin.

A coupling cable 98 is coupled to the photodetection unit 74 of the photodetection device 70. The coupling cable 98 transmits a detection signal of the photodetection unit 74 which is converted into an electric signal to the detection signal processing unit 92. The coupling cable 98 is coupled to a connector 99 through the opening 97 formed in the circuit board 96. The connector 99 is electrically coupled to the detection signal processing unit 92 and the central control unit 93. The detection signal processing unit 92 and the central control unit 93 are provided on the circuit board 96. The circuit board 96 may cover the cross dichroic prism 50. Since the coupling cable 98 passes through the opening 97, a wiring length of the coupling cable 98 can be reduced.

### 1.5. Time Change of Liquid Crystal Panel And Photoluminescence

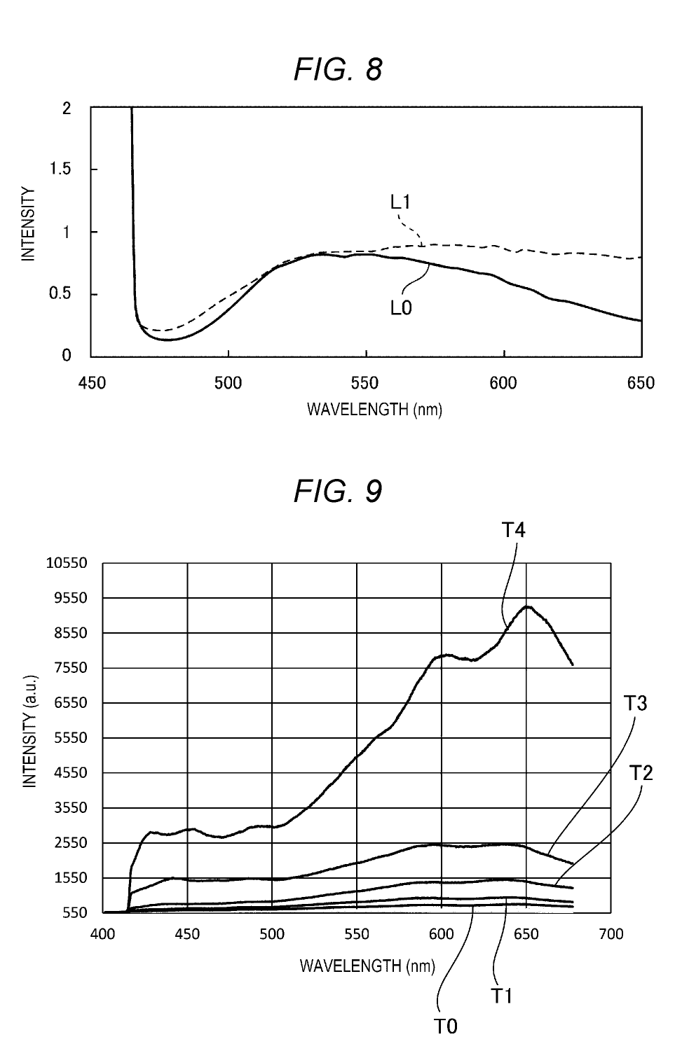

FIG. 8 is a graph showing a temporal change in photoluminescence when a liquid crystal layer is irradiated with blue light. In FIG. 8, a horizontal axis represents a measurement wavelength, and a vertical axis represents an intensity of radiation light observed from the liquid crystal layer irradiated with blue light. An initial spectrum when the liquid crystal layer starts being irradiated with blue light is indicated by a solid line L0, and a spectrum when the liquid crystal layer is irradiated with blue light for a certain period of time is indicated by a broken line L1. Spectra other than the spectra corresponding to the incident light are presumed to be based on photoluminescence of a deteriorating substance generated in the liquid crystal layer. FIG. 8 and FIGS. 9 to 11 to be described later show a case where both blue light and photoluminescence are detected.

As shown in FIG. 8, when the liquid crystal layer is continuously irradiated with blue light having an intensity peak near 450 nm for a certain period of time, an intensity of the spectrum of the radiation light emitted from the liquid crystal layer increases. In particular, an intensity in a wavelength band from 550 nm to 650 nm increases, and the radiation light is observed as light having an increased ratio of a red component. It is presumed that prescribed light is radiated when electrons transition between liquid crystal molecules, and radiation light including phosphorescence having a wavelength of 550 nm to 650 nm is emitted when a deteriorating substance is interposed due to a photochemical reaction or the like.

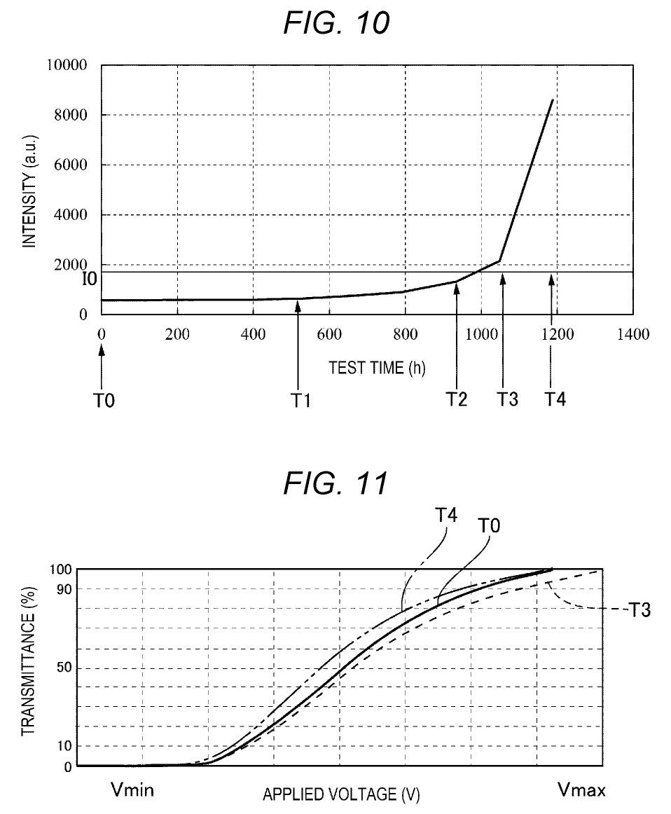

FIGS. 9 and 10 are graphs showing a temporal change in photoluminescence in an accelerated deterioration test of a liquid crystal panel. FIG. 9 shows spectra at test times T0, T1, T2, T3, and T4. In FIG. 9, the horizontal axis represents the measurement wavelength, and the vertical axis represents the intensity of the radiation light observed from the liquid crystal layer. FIG. 10 shows the temporal change of the intensity of the radiation light in a band from 500 nm to 650 nm. In FIG. 10, the horizontal axis represents test time, and the vertical axis represents the intensity of the radiation light in the above wavelength range observed from the liquid crystal layer. FIG. 10 shows points corresponding to the test times T0, T1, T2, T3, and T4 shown in FIG. 9. In the accelerated deterioration test shown in FIGS. 9 and 10, the liquid crystal panel is irradiated with blue light having a high luminous flux density, and the radiation light of the liquid crystal panel is observed from a light incident side.

FIG. 11 is a graph showing electro-optical characteristics (V-T characteristics) of the liquid crystal panel. In FIG. 11, the vertical axis represents transmittance, and the horizontal axis represents a voltage applied to a liquid crystal layer of the liquid crystal panel. FIG. 11 shows V-T curves of the liquid crystal panel corresponding to the test times T0, T3, and T4, respectively.

A main factor of the temporal change in the intensity of the radiation light observed in the liquid crystal panel is the temporal change in an intensity of photoluminescence from the liquid crystal panel. The test time T0 indicates an initial state, and T0 < T1 < T2 < T3 < T4. Irradiation with blue light increases an intensity of a spectrum of photoluminescence radiation light. At the test times T1 and T2, the intensity of photoluminescence increases in the band from 500 nm to 650 nm. At the test times T3 and T4, the intensity of photoluminescence in all measurement wavelength ranges further increases, and the intensity of photoluminescence in the band from 500 nm to 650 nm significantly increases. For example, the test times T3 and T4 are 1.1 times and 1.2 times the test time T2, respectively. The intensities of photoluminescence at the test times T3 and T4 are, for example, 1.5 times and 3 times or more the intensity of photoluminescence at the test time T2, respectively. The V-T curve of the liquid crystal panel at the test time T3 changes in a darker direction, the V-T curve of the liquid crystal panel at the test time T4 changes in a brighter direction, and display quality of the liquid crystal panel deteriorates. It can be seen that the deterioration of the liquid crystal panel rapidly progresses from the test time T3. Therefore, the deterioration degree of the liquid crystal panel can be grasped from a change in the intensity of photoluminescence.

As a factor of the increase in the intensity of photoluminescence from the liquid crystal panel, it is presumed that a concentration of the deteriorating substance in the liquid crystal layer increases. After the test time T4, the deterioration further progresses, and the liquid crystal panel cannot recover the display quality even by correction or the like, and lifetime of the liquid crystal panel expires. As determination of the lifetime, for example, as shown in FIG. 10, a time point when an intensity I0 of photoluminescence observed between the test time T2 and the test time T3 is detected is determined as the lifetime of the liquid crystal panel. The intensity I0 of photoluminescence can be set to the limit value I0 corresponding to the liquid crystal panel.

Therefore, by detecting the intensity of photoluminescence radiated from the liquid crystal panel, deterioration of the liquid crystal layer and deterioration of the liquid crystal panel due to deterioration of the liquid crystal layer can be monitored. When the liquid crystal layer is continuously irradiated with blue light for a certain period of time, the radiation light radiated from the liquid crystal panel further includes fluorescence having a wavelength of 600 nm to 650 nm. In addition, when the light applied to the liquid crystal layer has a short wavelength, deterioration due to a photochemical reaction or the like easily progresses.

### 1.6. Operations

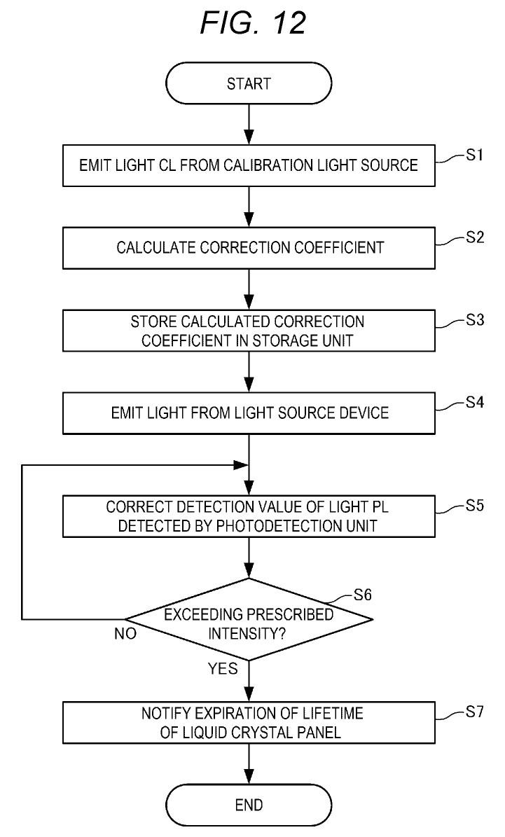

Next, an operation of the display device 100 according to the embodiment will be described with reference to the drawings. FIG. 12 is a flowchart showing the operation of the display device 100 according to the embodiment.

For example, a user operates an operation unit (not shown) to output, to the control unit 90, a processing start signal for starting processing. The operation unit is implemented by, for example, a mouse, a keyboard, or a touch panel. Before outputting the processing start signal, the user brings the connector 164 into a state of being coupled to the coupling portion 82 as shown in FIG. 2. When the processing start signal is received, the control unit 90 starts the processing.

First, as shown in FIG. 12, the control unit 90 emits the light CL by the calibration light source 160 (step S1). As shown in FIG. 2, the light CL reaches the photodetection unit 74 through the first light guide unit 71 and is detected by the photodetection unit 74. The emission of the light CL from the calibration light source 160 may be executed by control by an external device instead of control by the control unit 90.

Next, the control unit 90 calculates a correction coefficient for correcting a detection value of the light PL based on a detection value of the light CL detected by the photodetection unit 74 (step S2). An intensity of the light CL emitted from the calibration light source 160 is known. For example, when the intensity of the light CL emitted from the calibration light source 160 is I_{A} and the intensity of the light CL detected by the photodetection unit 74 is I_{B}, the control unit 90 calculates the correction coefficient as I_{A}/I_{B}. That is, the correction coefficient is a coefficient that corrects the known intensity I_{A} to the detection intensity I_{A}. When a wavelength sensitivity curve of the photodetection unit 74 is known, the correction coefficient can be applied to a freely selected wavelength range to execute correction.

Next, the control unit 90 stores the calculated correction coefficient in the storage unit 95 (step S3). The control unit 90 may display the calculated correction coefficient on a display unit (not shown). The display unit is implemented by, for example, a liquid crystal display (LCD), an organic electroluminescence (EL) display, an electrophoretic display (EPD), or a touch panel display. After confirming the display of the display unit, the user detaches the connector 164 from the coupling portion 82 and attaches the light shielding cap 170 to the coupling portion 82 as shown in FIG. 3. As a result, the coupling portion 82 is shielded, and incidence of the light CL on the first light guide unit 71 is prevented.

Next, the light source control unit 91 of the control unit 90 emits light by the light source device 10 (step S4). Accordingly, the light BL is incident on the liquid crystal panel 42 of the light modulator 40B. Specifically, the light BL is incident on the liquid crystal layer 130 of the liquid crystal panel 42. The liquid crystal layer 130 is irradiated with the light BL so that the light PL is radiated from the deteriorating substance 132. The light PL reaches the photodetection unit 74 through the second light guide unit 72 and is detected by the photodetection unit 74.

Next, the detection signal processing unit 92 of the control unit 90 corrects the detection value of the light PL detected by the photodetection unit 74 based on the detection value of the light CL detected by the photodetection unit 74 (step S5). Specifically, the control unit 90 reads the correction coefficient calculated in step S2 from the storage unit 95, and corrects the detection value of the light PL detected by the photodetection unit 74 using the read correction coefficient.

Next, the deterioration determination unit 94 of the control unit 90 executes processing of determining whether a corrected intensity of the light PL exceeds a prescribed value (step S6). The prescribed value may be set in consideration of the limit value I0 shown in FIG. 10. The display device 100 may be configured such that the processing of step S6 is automatically executed at a stage at which prescribed time elapsed from the start of emission of light from the light source device 10. Such a configuration can be implemented by executing a program using a microcomputer or the like.

When determining that the intensity of the corrected light PL does not exceed the prescribed value ("NO" in step S6), the control unit 90 returns the processing to step S5. Then, steps S5 and S6 are repeated until it is determined in step S6 that the intensity of the corrected light PL exceeds the prescribed value.

On the other hand, when determining that the intensity of the corrected light PL exceeds the prescribed value ("YES" in step S6), the control unit 90 executes processing of notifying expiration of the lifetime of the liquid crystal panel 42 (step S7). Specifically, the control unit 90 displays, on a display unit (not shown), a fact that the lifetime of the liquid crystal panel 42 expires or a period until the lifetime of the liquid crystal panel 42 is expected to expire. For example, after receiving the notification from the control unit 90, the user performs maintenance of the liquid crystal panel 42. The control unit 90 may store the determination result in the storage unit 95, or may transmit the determination result to a server on a network by a communication unit (not shown) and record the determination result.

Thereafter, the control unit 90 ends the processing.

When determining that the intensity of the corrected light PL exceeds the prescribed value, for example, the control unit 90 may weaken an output of the light source device 10. Accordingly, a progress of deterioration of the liquid crystal panel 42 can be delayed, and thus time until the maintenance by the user can be ensured with a margin.

### 1.7. Functions And Effects

The display device 100 includes the exterior housing 81, the liquid crystal panel 42 of the light modulator 40B, the liquid crystal panel 42 provided in the exterior housing 81 and configured to radiate the light PL that is second light including light in a wavelength range longer than a first wavelength range when the light BL that is first light including light in the first wavelength range is incident, the photodetection unit 74 configured to detect the light PL and the light CL that is third light incident from outside the exterior housing 81, the first light guide unit 71 configured to guide the light CL to the photodetection unit 74, and the control unit 90 configured to correct a detection value of the light PL detected by the photodetection unit 74 based on a detection value of the light CL detected by the photodetection unit 74.

For this reason, in the display device 100, the detection value of the light PL can be corrected using the detection value of the light CL, and thus a deterioration degree of the liquid crystal panel 42 can be accurately detected. For example, the deterioration degree of the liquid crystal panel 42 can be accurately detected even when sensitivity of the photodetection unit 74 varies and an amplifier or an analog/digital (A/D) converter provided in the circuit board 96 varies. Further, it is not necessary to provide the calibration light source 160 that emits the light CL in the exterior housing 81, and thus costs can be reduced.

In the display device 100, the light CL includes light in a wavelength range longer than the first wavelength range. For this reason, in the display device 100, the detection value of the light PL can be corrected using light in the same wavelength range as the light PL, and the deterioration degree of the liquid crystal panel 42 can be accurately detected.

The display device 100 includes the light shielding cap 170 configured to prevent incidence of the light CL on the first light guide unit 71. For this reason, in the display device 100, external light can be prevented from being incident on the photodetection unit 74 and the light PL can be accurately detected.

The display device 100 calculates a correction coefficient for correcting the detection value of the light PL based on the detection value of the light CL. For this reason, in the display device 100, an absolute value of an intensity of the light PL can be calculated, and the deterioration degree of the liquid crystal panel 42 can be accurately detected.

The display device 100 includes the storage unit 95 in which the correction coefficient is stored. For this reason, in the display device 100, the detection value of the light PL can be corrected by reading the calculated correction coefficient from the storage unit 95.

The display device 100 includes the second light guide unit 72 configured to guide the light PL to the photodetection unit 74. For this reason, in the display device 100, the light PL can be efficiently guided to the photodetection unit 74.

In the display device 100, the diameter D1 of the first light guide unit 71 is smaller than the diameter D2 of the second light guide unit 72. For this reason, in the display device 100, an allowable curvature of the first light guide unit 71 can be reduced, and thus a degree of freedom of wiring in the exterior housing 81 can be increased. Accordingly, a degree of freedom in an arrangement of the coupling portion 82 can be increased, and for example, the coupling portion 82 can be consolidated together with interfaces of various signals. Since an output of the calibration light source 160 can be set higher than that of the light source device 10, the photodetection unit 74 can sufficiently detect the light CL emitted from the calibration light source 160 even when the diameter D1 of the first light guide unit 71 is small.

The display device 100 includes the light shielding body 76 surrounding the photodetection unit 74. For this reason, in the display device 100, external light can be prevented from being incident on the photodetection unit 74 and the light PL can be accurately detected.

The display device 100 includes the wavelength filter 75 provided between the light emission surface 72b of the second light guide unit 72 and the photodetection unit 74 and configured to reduce light in the first wavelength range. For this reason, in the display device 100, the light in the first wavelength range incident on the photodetection unit 74 can be reduced, and the light PL can be accurately detected.

### 2. Modifications of Display Device

### 2.1. First Modification

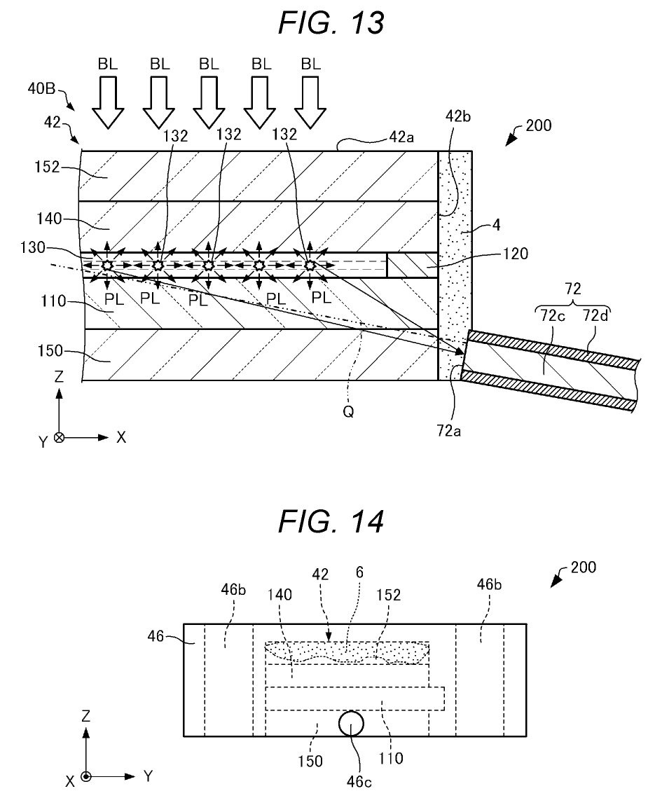

Next, a display device according to a first modification of the embodiment will be described with reference to the drawings. FIG. 13 is a sectional view schematically showing a display device 200 according to the first modification of the embodiment. FIG. 14 is a side view schematically showing the display device 200 according to the first modification of the embodiment. For convenience, in FIG. 13, members other than the liquid crystal panel 42, the second light guide unit 72, and the index matching material 4 are not shown. In FIG. 14, members other than the liquid crystal panel 42 and the holder 46 are not shown. In FIGS. 13 and 14, the liquid crystal panel 42 is shown in a simplified manner.

Hereinafter, members of the display device 200 according to the first modification of the embodiment which have similar functions to component members of the display device 100 are denoted by the same reference numerals and description thereof in detail will be omitted.

In the display device 100 described above, as shown in FIGS. 6 and 7, the light incident surface 72a of the second light guide unit 72 and the through hole 46c overlap the second dustproof substrate 152 when viewed from the direction orthogonal to the normal direction.

In contrast, in the display device 200, as shown in FIG. 13, the light incident surface 72a of the second light guide unit 72 overlaps the first dustproof substrate 150 when viewed from the direction orthogonal to the normal direction. As shown in FIG. 14, the through hole 46c overlaps the first dustproof substrate 150 when viewed from the direction orthogonal to the normal direction.

In the example shown in FIG. 13, the second light guide unit 72 is inclined relative to the X-axis direction. The second light guide unit 72 is inclined such that the light incident surface 72a faces the liquid crystal layer 130. The light incident surface 72a of the second light guide unit 72 has a perpendicular Q intersecting the liquid crystal layer 130. For this reason, in the display device 200, the light incident surface 72a of the second light guide unit 72 can efficiently capture the light PL as compared with a case where the light incident surface does not have a perpendicular intersecting the liquid crystal layer.

In the example shown in FIG. 14, the second dustproof substrate 152 and an inner wall of the holder 46 are bonded by a thermally conductive adhesive 6. As shown in FIG. 14, the thermally conductive adhesive 6 may wrap around a side surface of the second dustproof substrate 152. Therefore, by forming the through hole 46c in a manner of overlapping the first dustproof substrate 150, the light PL can be efficiently incident on the light incident surface 72a of the second light guide unit 72 without being affected by the thermally conductive adhesive 6.

### 2.2. Second Modification

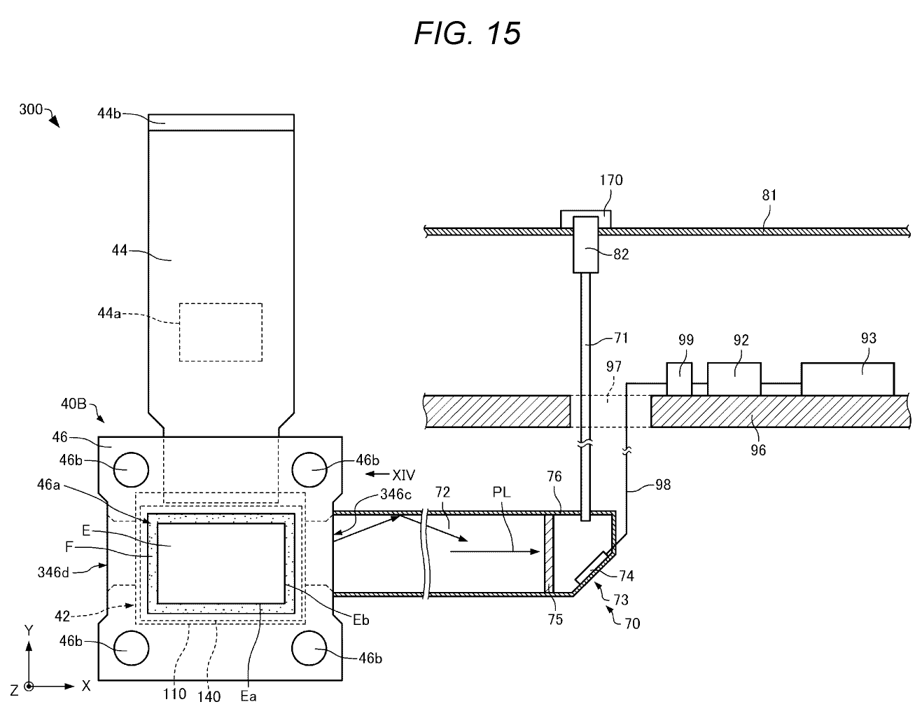

Next, a display device according to a second modification of the embodiment will be described with reference to the drawings. FIG. 15 schematically shows a display device 300 according to the second modification of the embodiment. FIG. 16 is a side view schematically showing the display device 300 according to the second modification of the embodiment, as viewed in a direction of an arrow XIV in FIG. 15. For convenience, in FIG. 16, members other than the liquid crystal panel 42 and the holder 46 are not shown. In FIG. 16, the liquid crystal panel 42 is shown in a simplified manner.

Hereinafter, members of the display device 300 according to the second modification of the embodiment which have similar functions to component members of the display devices 100 and 200 are denoted by the same reference numerals and description thereof in detail will be omitted.

In the display device 100 described above, as shown in FIG. 3, the second light guide unit 72 is an optical fiber.

In contrast, in the display device 300, as shown in FIG. 15, the second light guide unit 72 is implemented by extending the light shielding body 76 to a liquid crystal panel 42 side. The second light guide unit 72 is provided integrally with the light shielding body 76. For this reason, the amount of the light PL guided to the photodetection unit 74 can be increased. An inner surface of the second light guide unit 72 is preferably covered with a reflective material formed by plating or the like. The light PL is repeatedly reflected by the inner surface of the second light guide unit 72 and reaches the photodetection unit 74.

The holder 46 is formed with a notch 346c. In the example shown in FIG. 16, the first dustproof substrate 150 and the element substrate 110 are exposed from the notch 346c. The notch 346c can increase the amount of the light PL to the second light guide unit 72.

As shown in FIG. 15, the holder 46 is formed with a notch 346d on an opposite side from the notch 346c. The notches 346c and 346d are formed symmetrically relative to, for example, a line in the Y-axis direction which passes through a center of the display region E. For this reason, discomfort can be reduced when the display device 300 is visually recognized. For example, when a notch is formed on one side and no notch is formed on the other side, a distribution of a thickness of the liquid crystal layer 130 in the display region E may be asymmetric relative to a display center due to a difference in a stress distribution of the liquid crystal panel. In this case, unevenness in the thickness of the liquid crystal layer 130 may be easily recognized as unnatural color unevenness. In the display device 300, such a sense of discomfort can be reduced. Instead of a notch, a through hole may be formed.

The embodiment and the modifications described above are examples and the present disclosure is not limited thereto. For example, the embodiment and the modifications can also be combined as appropriate.

The present disclosure includes substantially the same configurations as configurations described in the embodiment, for example, configurations having the same functions, methods, and results or configurations having the same objects and effects. The present disclosure includes configurations in which unnecessary portions of the configurations described in the embodiment are replaced. The present disclosure includes configurations that achieve the same functions and effects or configurations that can achieve the same objects as the configurations described in the embodiment. The present disclosure includes configurations obtained by adding publicly-known techniques to the configurations described in the embodiment.

Following contents are derived from the embodiment and the modifications described above.

According to an aspect, a display device includes: an exterior housing; a liquid crystal panel provided in the exterior housing and configured to radiate second light including light in a wavelength range longer than a first wavelength range when first light including light in the first wavelength range is incident; a photodetection unit configured to detect the second light and third light that is incident from outside the exterior housing; a first light guide unit configured to guide the third light to the photodetection unit; and a control unit configured to correct a detection value of the second light which is detected by the photodetection unit based on a detection value of the third light which is detected by the photodetection unit.

According to the display device, a deterioration degree of the liquid crystal panel can be accurately detected.

In the display device according to the aspect, the third light may include light in a wavelength range longer than the first wavelength range.

According to the display device, the detection value of the second light can be corrected using light in the same wavelength range as the second light, and the deterioration degree of the liquid crystal panel can be accurately detected.

In the display device according to the aspect, the display device may further include a light shielding cap configured to prevent incidence of the third light on the first light guide unit.

According to the display device, external light can be prevented from being incident on the photodetection unit and the second light can be accurately detected.

In the display device according to the aspect, the control unit may calculate a correction coefficient for correcting the detection value of the second light based on the detection value of the third light.

According to the display device, an absolute value of an intensity of the second light can be calculated, and the deterioration degree of the liquid crystal panel can be accurately detected.

In the display device according to the aspect, the display device may further include a storage unit in which the correction coefficient is stored.

According to the display device, the detection value of the second light can be corrected by reading the calculated correction coefficient from the storage unit.

In the display device according to the aspect, the display device may further include a second light guide unit configured to guide the second light to the photodetection unit.

According to the display device, the second light can be efficiently guided to the photodetection unit.

In the display device according to the aspect, the first light guide unit may have a diameter smaller than a diameter of the second light guide unit.

According to the display device, an allowable curvature of the first light guide unit can be reduced, and thus a degree of freedom of wiring in the exterior housing can be increased.

In the display device according to the aspect, the display device may further include a light shielding body surrounding the photodetection unit.

According to the display device, external light can be prevented from being incident on the photodetection unit and the second light can be accurately detected.

In the display device according to the aspect, the display device may further include a wavelength filter provided between a light emission surface of the second light guide unit and the photodetection unit and configured to reduce light in the first wavelength range.

According to the display device, the light in the first wavelength range incident on the photodetection unit can be reduced, and the second light can be accurately detected.

What is claimed is:

1. A display device comprising:
an exterior housing;
a liquid crystal panel provided in the exterior housing and configured to radiate second light including light in a wavelength range longer than a first wavelength range when first light including light in the first wavelength range is incident;
a photodetection unit configured to detect the second light and third light that is incident from outside the exterior housing;
a first light guide unit configured to guide the third light to the photodetection unit; and
a control unit configured to correct a detection value of the second light which is detected by the photodetection unit based on a detection value of the third light which is detected by the photodetection unit.

2. The display device according to claim 1, wherein
the third light includes light in a wavelength range longer than the first wavelength range.

3. The display device according to claim 1, further comprising:
a light shielding cap configured to prevent incidence of the third light on the first light guide unit.

4. The display device according to claim 1, wherein
the control unit calculates a correction coefficient for correcting the detection value of the second light based on the detection value of the third light.

5. The display device according to claim 4, further comprising:
a storage unit in which the correction coefficient is stored.

6. The display device according to claim 1, further comprising:
a second light guide unit configured to guide the second light to the photodetection unit.

7. The display device according to claim 6, wherein
the first light guide unit has a diameter smaller than a diameter of the second light guide unit.

8. The display device according to claim 1, further comprising:
a light shielding body surrounding the photodetection unit.

9. The display device according to claim 6, further comprising:
a wavelength filter provided between a light emission surface of the second light guide unit and the photodetection unit and configured to reduce light in the first wavelength range.
